(19) United States
(12) Patent Application Publication
(10) Pub. No.: US 2016/0328155 A1
(43) Pub. Date: Nov. 10, 2016

(54) MEMORY SYSTEM AND OPERATING METHOD THEREOF

(71) Applicant: SK hynix Inc., Gyeonggi-do (KR)

(72) Inventor: Gi-Pyo UM, Gyeonggi-do (KR)

(21) Appl. No.: 14/863,027

(22) Filed: Sep. 23, 2015

(30) Foreign Application Priority Data
May 7, 2015 (KR) 10-2015-0063645

(51) Int. Cl. G06F 3/06

(52) U.S. Cl. CPC G06F 3/065; G06F 3/0604; G06F 3/0679; G06F 3/064

(57) ABSTRACT

A memory system includes multiple blocks each including multiple pages; a selective copy unit suitable for determining whether data stored in each of multiple valid pages included in a victim block has a predetermined pattern, and copying a valid normal data to a free block; and a storage unit suitable for updating mapping information of a logical address for a valid pattern data to the predetermined pattern of the valid pattern data. The valid normal data does not have the predetermined pattern. The valid pattern data has the predetermined pattern.

### CROSS-REFERENCE TO RELATED APPLICATION

This application claims priority under 35 U.S.C. §119 to Korean Patent Application No. 10-2015-0063645 filed on May 7, 2015 in the Korean Intellectual Property Office, the disclosure of which is incorporated herein by reference in its entirety.

### TECHNICAL FIELD

Exemplary embodiments relate to a semiconductor design technology, and more particularly, to a memory system capable of supporting a garbage collection operation and an operating method thereof.

### DISCUSSION OF THE RELATED ART

The computing environment paradigm has shifted to ubiquitous computing systems that can be used anytime and anywhere. Because of this, the use of portable electronic devices such as mobile phones, digital cameras, and notebook computers has rapidly increased. Such portable electronic devices generally use memory systems with memory devices, that is, data storage devices. Data storage devices are used as main memory or auxiliary memory devices within the portable electronic devices.

Data storage devices provide excellent stability and durability and operate with high information access speed and low power consumption, since they have no moving parts. Examples of data storage devices having these advantages include universal serial bus (USB) memory devices, memory cards having various interfaces, and solid state drives (SSD).

### SUMMARY

Various embodiments are directed to a memory system capable of minimizing copying of valid data during a garbage collection operation and an operating method thereof.

In an embodiment, a memory system may include multiple blocks each including multiple pages; a selective copy unit suitable for determining whether data stored in each of multiple valid pages included in a victim block has a predetermined pattern, and copying a valid normal data to a free block; and a storage unit suitable for updating mapping information of a logical address for a valid pattern data to the predetermined pattern of the valid pattern data. The valid normal data may not have the predetermined pattern, and may be originally stored in a valid normal page. The valid pattern data may have the predetermined pattern, and may be originally stored in a valid pattern page. The valid normal page and the valid pattern page may be included in the multiple valid pages.

The memory system may further include an erase operation unit suitable for performing an erase operation on the victim block.

The storage unit may further update mapping information of a logical address for the valid normal data to a physical address for the valid normal page copied to the free block.

The selective copy unit may include: a selection operation section suitable for determining whether each of the multiple valid pages is the valid normal page or the valid pattern page, and selectively enabling a determination result signal according to a result of the determination; and a copy operation section suitable for copying the valid normal data to the free block in response to the determination result signal.

The selection operation section may include: a pattern storage part suitable for storing the predetermined pattern; and a pattern detection part suitable for determining whether each of the multiple valid pages is the valid normal page or the valid pattern page by comparing the data stored in each of the multiple valid pages with the predetermined pattern, and selectively enabling a determination result signal according to a result of the determination.

The pattern storage part may store multiple different predetermined patterns, and the pattern detection part may compare part of the data stored in each of the multiple valid pages with each of the multiple predetermined patterns.

The storage unit may store one among the multiple predetermined patterns, which the valid pattern data has, along with the logical address for the valid pattern data.

The memory system may further include a read operation unit suitable for generating and outputting data by using the predetermined pattern of the valid pattern data in response to a read command having the logic address for the valid pattern data.

The read operation unit may generate the data by repeatedly concatenating the predetermined pattern of the valid pattern data.

In an embodiment, a method for operating a memory system including a plurality of blocks each including a plurality of pages may include: determining whether data stored in each of multiple valid pages included in a victim block has a predetermined pattern, and copying a valid normal data to a free block; and updating mapping information of a logical address for a valid pattern data to the predetermined pattern of the valid pattern data. The valid normal data may not have the predetermined pattern, and may be originally stored in a valid normal page. The valid pattern data may have the predetermined pattern, and may be originally stored in a valid pattern page. The valid normal page and the valid pattern page may be included in the multiple valid pages.

The method may further include performing an erase operation to the victim block.

The method may further include updating mapping information of a logical address for the valid normal data to a physical address for the valid normal page copied to the free block.

The determining and copying may include determining whether each of the multiple valid pages is the valid normal page or the valid pattern page, and selectively enabling a determination result signal according to a result of the determination; and copying the valid normal data to the free block in response to the determination result signal.

The determining may be performed by comparing the data stored in each of the multiple valid pages with the predetermined pattern.

There may be multiple predetermined patterns, and the predetermined patterns may be different from one another, and the comparing may compare part of the data stored in each of the multiple valid pages with each of the multiple predetermined patterns.

The updating may store one among the multiple predetermined patterns, which the valid pattern data has, along with the logical address for the valid pattern data.

The method may further include generating and outputting data by using the predetermined pattern of the valid pattern data in response to a read command having the logic address for the valid pattern data.

The generating of data may generate the data by repeatedly concatenating the predetermined pattern of the valid pattern data.

In an embodiment, a memory controller may include: a determination means suitable for determining whether valid data of a victim block within a memory device is valid normal data or valid pattern data in order to allow the memory device to copy the valid normal data to a free block within the memory device; a map management means suitable for updating mapping information of a logical address for the valid pattern data to a predetermined pattern of the valid pattern data, and updating mapping information of the logical address for the valid normal data to a physical address for the valid normal data copied to the free block; and an erase means suitable for allowing the memory device to perform an erase operation to the victim block. The valid normal data may not have the predetermined pattern. The valid pattern data may have the predetermined pattern.

According to the embodiments, during a garbage collection operation, when the value of data stored in a valid page of a victim block set as a copy target has a predetermined pattern, mapping relation between logical and physical addresses of the valid page may be updated to the physical address of the predetermined pattern instead of copying the data of the valid page.

The update of the mapping information may eliminate the writing of the data of the valid page to the free block, and thus may shorten the operation time of the garbage collection operation as well as maximizing a number of valid pages to be copied to the free block.

Further, due to the update to the mapping relation between the logic address of the valid page and the predetermined pattern, the data of the valid page may be outputted from the predetermined pattern without a read operation of the data stored in memory cells, which reduces the operation time for the read operation after the garbage collection operation.

### BRIEF DESCRIPTION OF THE DRAWINGS

FIG. 1 is a diagram illustrating a data processing system including a memory system in accordance with an embodiment.

FIG. 2 is a diagram illustrating a memory device in the memory system shown in FIG. 1.

FIG. 3 is a circuit diagram illustrating a memory block in a memory device in accordance with an embodiment.

FIGS. 4 to 11 are diagrams schematically illustrating the memory device shown in FIG. 2.

FIG. 12 is a schematic diagram illustrating a garbage collection operation of a memory system in accordance with an embodiment.

FIGS. 13A and 13B are schematic diagrams illustrating operations of a selective copy unit shown in FIG. 12.

FIG. 14 is a flow chart illustrating an operation of a selective copy unit shown in FIG. 12.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via an intervening element therebetween. Furthermore, when it is described that one “comprises” (or “includes”) or “has” some elements, it should be understood that it may comprise (or include) or have only those elements, or it may comprise (or include) or have other elements as well as those elements if there is no specific limitation. The terms of a singular form may include multiple forms unless referred to the contrary.

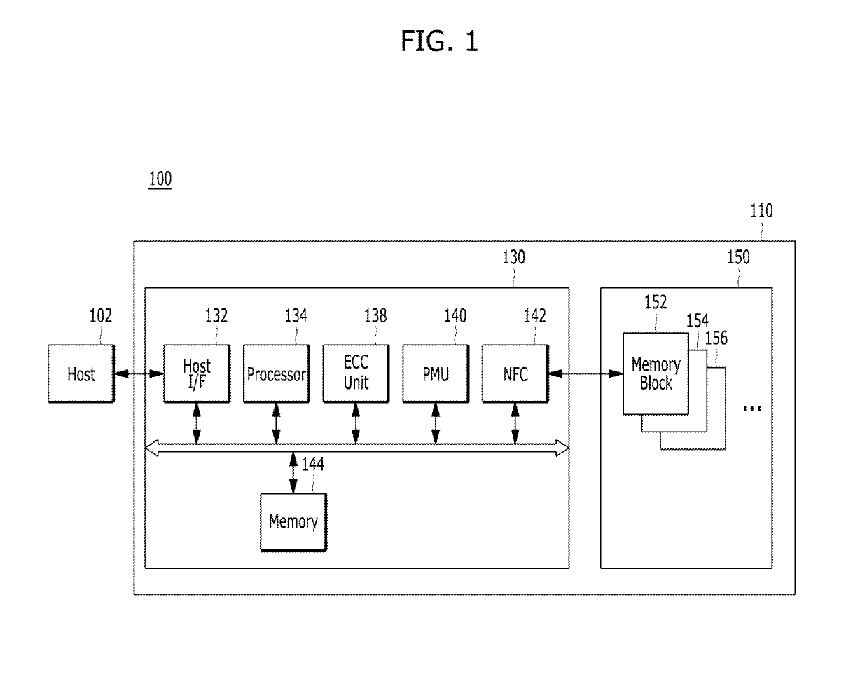

FIG. 1 is a block diagram illustrating a data processing system including a memory system in accordance with an embodiment.

Referring to FIG. 1, a data processing system 100 may include a host 102 and a memory system 110.

The host 102 may include, for example, a portable electronic device such as a mobile phone, an MP3 player and a laptop computer or an electronic device such as a desktop computer, a game player, a TV and a projector.

The memory system 110 may operate in response to a request from the host 102, and in particular, store data to be accessed by the host 102. In other words, the memory system 110 may be used as a main memory system or an auxiliary memory system of the host 102. The memory system 110 may be implemented with any one of various kinds of storage devices, according to the protocol of a host interface to be electrically coupled with the host 102. The memory system 110 may be implemented with any one of various kinds of storage devices such as a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and so forth.

The storage devices for the memory system 110 may be implemented with a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The memory system 110 may include a memory device 150 which stores data to be accessed by the host 102, and a controller 130 which may control storage of data in the memory device 150.

The controller 130 and the memory device 150 may be integrated into one semiconductor device. For instance, the controller 130 and the memory device 150 may be integrated into one semiconductor device and configure a solid state drive (SSD). When the memory system 110 is used as the SSD, the operation speed of the host 102 that is electrically coupled with the memory system 110 may be significantly increased.

The controller 130 and the memory device 150 may be integrated into one semiconductor device and configure a memory card. The controller 130 and the memory card 150 may be integrated into one semiconductor device and configure a memory card such as a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card, a mini-SD, a micro-SD and an SDHC, and a universal flash storage (UFS) device.

For another instance, the memory system 110 may configure a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, or one of various component elements configuring a computing system.

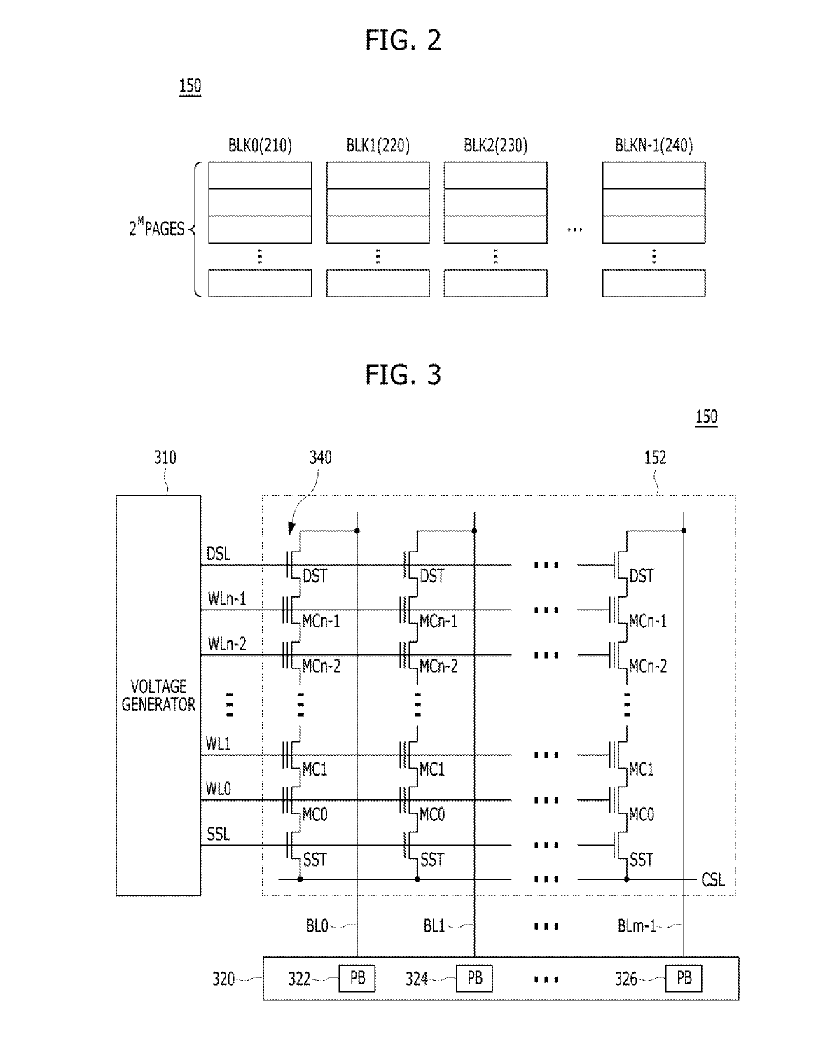

The memory device 150 of the memory system 110 may retain stored data when power supply is interrupted and, in particular, store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) are electrically coupled. The memory device 150 may be a nonvolatile memory device, for example, a flash memory. The flash memory may have a three-dimensional (3D) stack structure. The structure of the memory device 150 and the three-dimensional (3D) stack structure of the memory device 150 will be described later in detail with reference to FIGS. 2 to 11.

The controller 130 of the memory system 110 may control the memory device 150 in response to a request from the host 102. The controller 130 may provide the data read from the memory device 150, to the host 102, and store the data provided from the host 102 into the memory device 150. To this end, the controller 130 may control overall operations of the memory device 150, such as read, write, program and erase operations.

In detail, the controller 130 may include a host interface unit 132, a processor 134, an error correction code (ECC) unit 138, a power management unit 140, a NAND flash controller 142, and a memory 144.

The host interface unit 132 may process commands and data provided from the host 102, and may communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (DATA), small computer system interface (SCSI), enhanced small disk interface (ESDI), and integrated drive electronics (IDE).

The ECC unit 138 may detect and correct errors in the data read from the memory device 150 during the read operation. The FCC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, systems or devices for the error correction operation.

The PMU 140 may provide and manage power for the controller 130, that is, power for the component elements included in the controller 130.

The NEC 142 may serve as a memory interface between the controller 130 and the memory device 150 to allow the controller 130 to control the memory device 150 in response to a request from the host 102. The NEC 142 may generate control signals for the memory device 150 and process data under the control of the processor 134 when the memory device 150 is a flash memory and, in particular, when the memory device 150 is a NAND flash memory.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with volatile memory. The memory 144 may be implemented with a static random access memory (SRAM) or a dynamic random access memory (DRAM). As described above, the memory 144 may store data used by the host 102 and the memory device 150 for the read and write operations. To store the data, the memory 144 may include a program memory, a data memory, a write buffer, a read buffer, a map buffer, and so forth.

The processor 134 may control general operations of the memory system 110, and a write operation or a read operation for the memory device 150, in response to a write request or a read request from the host 102. The processor 134 may drive firmware, which is referred to as a flash translation layer (FTL), to control the general operations of the memory system 110. The processor 134 may be implemented with a microprocessor or a central processing unit (CPU).

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. Also, bad blocks that are a result of program failures seriously deteriorate the utilization efficiency of the memory device 150 having a 3D stack structure and the reliability of the memory system 100, and thus reliable bad block management is required.

FIG. 2 is a schematic diagram illustrating the memory device 150 shown in FIG. 1.

Referring to FIG. 2, the memory device 150 may include a plurality of memory blocks, for example, zeroth to (N−1)th blocks 210 to 240. Each of the plurality of memory blocks 210 to 240 may include a plurality of pages, for example, 2^{M} number of pages (2^{M} PAGES). Each of the plurality of pages may include a plurality of memory cells to which a plurality of word lines are electrically coupled.

Also, the memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

Each of the plurality of memory blocks 210 to 240 may store the data provided from the host device 102 during a write operation, and may provide stored data to the host 102 during a read operation.

FIG. 3 is a circuit diagram illustrating one of the plurality of memory blocks 152 to 156 shown in FIG. 1.

Referring to FIG. 3, the memory block 152 of the memory device 150 may include a plurality of cell strings 340 which are electrically coupled to bit lines BL0 to BLm-1, respectively. The cell string 340 of each column may include at least one drain select transistor DST and at least one source select transistor SST. A plurality of memory cells or a plurality of memory cell transistors MC0 to MCn-1 may be electrically coupled in series between the select transistors DST and SST. The respective memory cells MC0 to MCn-1 may be configured by multi-level cells (MLC) each of which stores data information of a plurality of bits. The strings 340 may be electrically coupled to the corresponding bit lines BL0 to BLm-1, respectively. For reference, in FIG. 3, ‘DSL’ denotes a drain select line, ‘SSL’ denotes a source select line, and ‘CSL’ denotes a common source line.

While FIG. 3 shows, as an example, the memory block 152 which is configured by NAND flash memory cells, it is to be noted that the memory block 152 of the memory device 150 in accordance with the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supply block 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The voltage supply block 310 may perform a voltage generating operation under the control of a control circuit (not shown). The voltage supply block 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

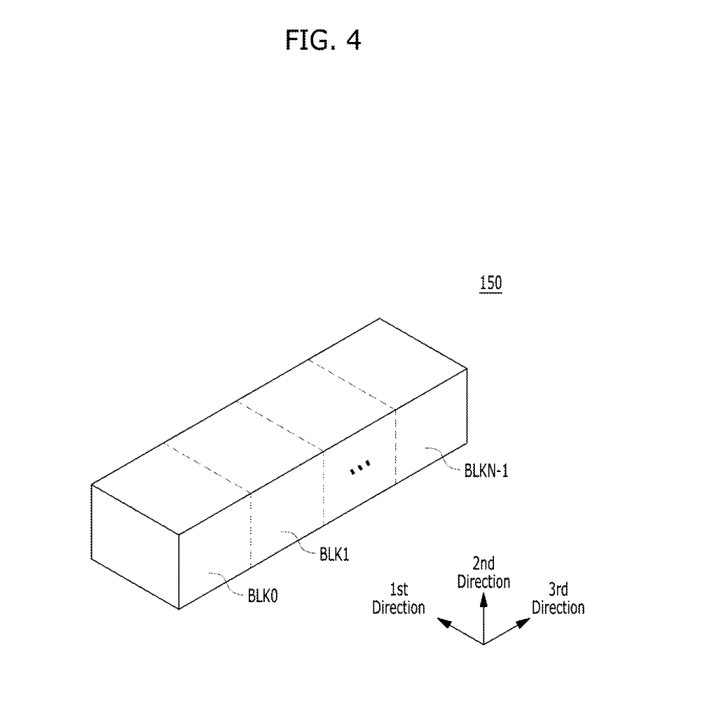

A read/write circuit 320 of the memory device 150 may be controlled by the control circuit, and may serve as a sense amplifier or a write driver according to an operation mode. During a verification/normal read operation, the read/write circuit 320 may serve as a sense amplifier for reading data from the memory cell array. Also, during a program operation, the read/write circuit 320 may serve as a write driver which drives bit lines according to data to be stored in the memory cell array. The read/write circuit 320 may receive data to be written in the memory cell array, from a buffer (not shown), during the program operation, and may drive the bit lines according to the inputted data. To this end, the read/write circuit 320 may include a plurality of page buffers 322, 324 and 326 respectively corresponding to columns (or bit lines) or pairs of columns (or pairs of bit lines), and a plurality of latches (not shown) may be included in each of the page buffers 322, 324 and 326. FIGS. 4 to 11 are schematic diagrams illustrating the memory device 150 shown in FIG. 1.

FIG. 4 is a block diagram illustrating an example of the plurality of memory blocks 152 to 156 of the memory device 150 shown in FIG. 1.

Referring to FIG. 4, the memory device 150 may include a plurality of memory blocks BLK0 to BLKN-1, and each of the memory blocks BLK0 to BLKN-1 may be realized in a three-dimensional (3D) structure or a vertical structure. The respective memory blocks BLK0 to BLKN-1 may include structures which extend in first to third directions, for example, an x-axis direction, a y-axis direction and a z-axis direction.

The respective memory blocks BLK0 to BLKN-1 may include a plurality of NAND strings NS which extend in the second direction. The plurality of NAND strings NS may be provided in the first direction and the third direction. Each NAND string NS may be electrically coupled to a bit line BL, at least one source select line SSL, at least one ground select line GSL, a plurality of word lines WL, at least one dummy word line DWL, and a common source line CSL. Namely, the respective memory blocks BLK0 to BLKN-1 may be electrically coupled to a plurality of bit lines BL, a plurality of source select lines SSL, a plurality of ground select lines GSL, a plurality of word lines WL, a plurality of dummy word lines DWL, and a plurality of common source lines CSL.

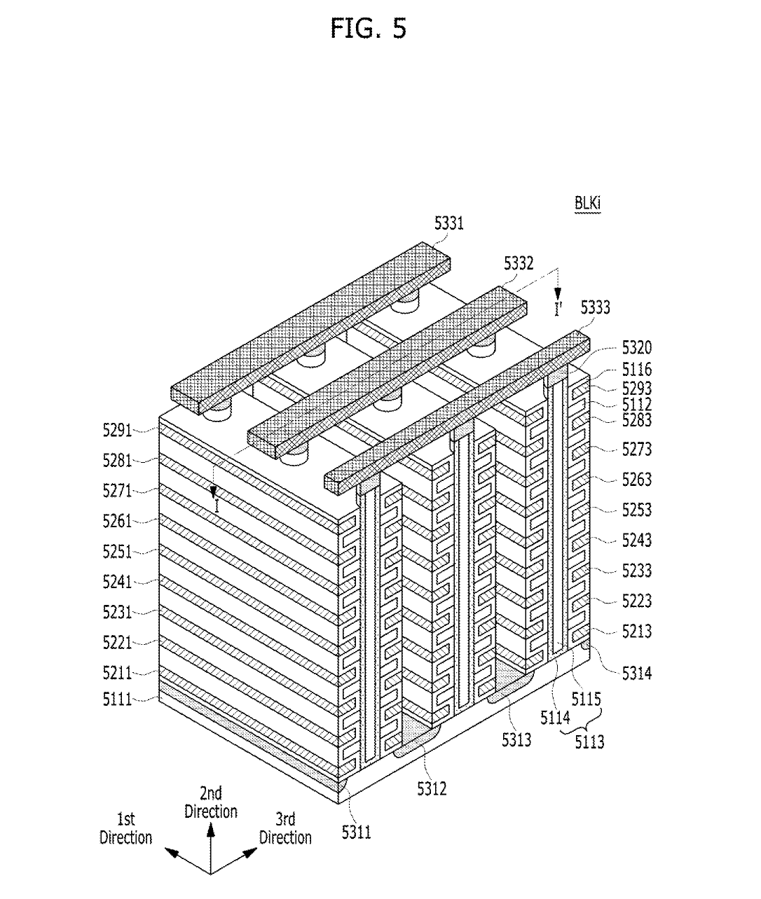

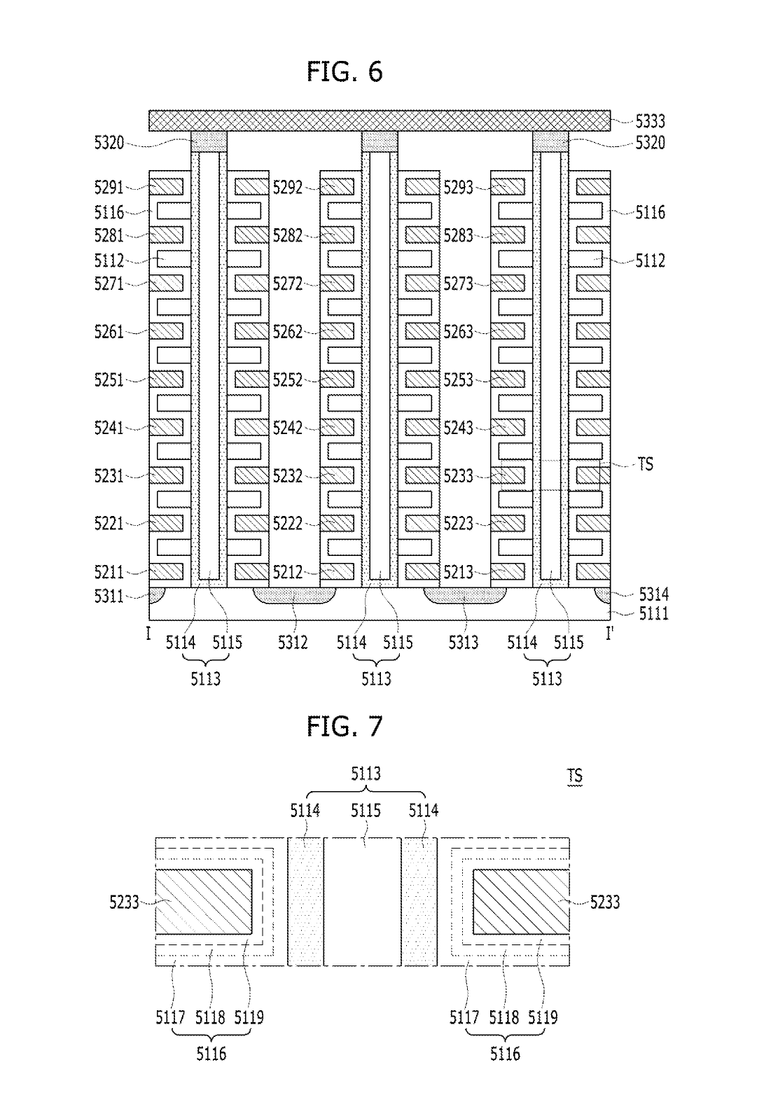

FIG. 5 is a perspective view of one BLKi of the plural memory blocks BLK0 to BLKN-1 shown in FIG. 4. FIG. 6 is a cross-sectional view taken along a line I-I′ of the memory block BLKi shown in FIG. 5.

Referring to FIGS. 5 and 6, the memory block BLKi of the memory device 150 may include a structure which extends in the first to third directions.

A substrate 5111 may be provided. The substrate 5111 may include a silicon material doped with a first type impurity. The substrate 5111 may include a silicon material doped with a p-type impurity or may be a p-type well, for example, a pocket p-well, and include an n-type well which surrounds the p-type well. While it is assumed in the embodiment that the substrate 5111 is p-type silicon, it is to be noted that the substrate 5111 is not limited to the p-type silicon.

A plurality of doping regions 5311 to 5314 which extend in the first direction may be provided over the substrate 5111. The plurality of doping regions 5311 to 5314 may contain a second type of impurity that is different from the substrate 5111. The plurality of doping regions 5311 to 5314 may be doped with an n-type impurity. While it is assumed here that first to fourth doping regions 5311 to 5314 are n-type, it is to be noted that the first to fourth doping regions 5311 to 5314 are not limited to being n-type.

In the region over the substrate 5111 between the first and second doping regions 5311 and 5312, a plurality of dielectric materials 5112 which extend in the first direction may be sequentially provided in the second direction. The dielectric materials 5112 and the substrate 5111 may be separated by a predetermined distance in the second direction. The dielectric materials 5112 may be separated by a predetermined distance in the second direction. The dielectric materials 5112 may include a dielectric material such as silicon oxide.

In the region over the substrate 5111 between the first and second doping regions 5311 and 5312, a plurality of pillars 5113 which are sequentially disposed in the first direction and pass through the dielectric materials 5112 in the second direction may be provided. The plurality of pillars 5113 may respectively pass through the dielectric materials 5112 and may be electrically coupled with the substrate 5111. Each pillar 5113 may be configured by a plurality of materials. The surface layer 5114 of each pillar 5113 may include a silicon material doped with the first type of impurity. The surface layer 5114 of each pillar 5113 may include a silicon material doped with the same type of impurity as the substrate 5111. While it is assumed here that the surface layer 5114 of each pillar 5113 may include p-type silicon, the surface layer 5114 of each pillar 5113 is not limited to being p-type silicon.

An inner layer 5115 of each pillar 5113 may be formed of a dielectric material. The inner layer 5115 of each pillar 5113 may be filled by a dielectric material such as silicon oxide.

In the region between the first and second doping regions 5311 and 5312, a dielectric layer 5116 may be provided along the exposed surfaces of the dielectric materials 5112, the pillars 5113 and the substrate 5111. The thickness of the dielectric layer 5116 may be less than half of the distance between the dielectric materials 5112. In other words, a region in which a material other than the dielectric material 5112 and the dielectric layer 5116 may be disposed, may be provided between (i) the dielectric layer 5116 provided over the bottom surface of a first dielectric material of the dielectric materials 5112 and (ii) the dielectric layer 5116 provided over the top surface of a second dielectric material of the dielectric materials 5112. The dielectric materials 5112 lie below the first dielectric material.

In the region between the first and second doping regions 5311 and 5312, conductive materials 5211 to 5291 may be provided over the exposed surface of the dielectric layer 5116. The conductive material 5211 which extends in the first direction may be provided between the dielectric material 5112 adjacent to the substrate 5111 and the substrate 5111. In particular, the conductive material 5211 which extends in the first direction may be provided between (i) the dielectric layer 5116 disposed over the substrate 5111 and (ii) the dielectric layer 5116 disposed over the bottom surface of the dielectric material 5112 adjacent to the substrate 5111.

The conductive material which extends in the first direction may be provided between (i) the dielectric layer 5116 disposed over the top surface of one of the dielectric materials 5112 and (ii) the dielectric layer 5116 disposed over the bottom surface of another dielectric material of the dielectric materials 5112, which is disposed over the dielectric material 5112. The conductive materials 5221 to 5281 which extend in the first direction may be provided between the dielectric materials 5112. The conductive material 5291 which extends in the first direction may be provided over the uppermost dielectric material 5112. The conductive materials 5211 to 5291 which extend in the first direction may be a metallic material. The conductive materials 5211 to 5291 which extend in the first direction may be a conductive material such as polysilicon.

In the region between the second and third doping regions 5312 and 5313, the same structures as between the first and second doping regions 5311 and 5312 may be provided. For example, in the region between the second and third doping regions 5312 and 5313, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5212 to 5292 which extend in the first direction may be provided.

In the region between the third and fourth doping regions 5313 and 5314, the same structures as between the first and second doping regions 5311 and 5312 may be provided. For example, in the region between the third and fourth doping regions 5313 and 5314, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5213 to 5293 which extend in the first direction may be provided.

Drains 5320 may be respectively provided over the plurality of pillars 5113. The drains 5320 may be silicon materials doped with second type impurities. The drains 5320 may be silicon materials doped with n-type impurities. While it is assumed for the sake of convenience that the drains 5320 include n-type silicon, it is to be noted that the drains 5320 are not limited to being n-type silicon. For example, the width of each drain 5320 may be larger than the width of each corresponding pillar 5113. Each drain 5320 may be provided in the shape of a pad over the top surface of each corresponding pillar 5113.

Conductive materials 5331 to 5333 which extend in the third direction may be provided over the drains 5320. The conductive materials 5331 to 5333 may be sequentially disposed in the first direction. The respective conductive materials 5331 to 5333 may be electrically coupled with the drains 5320 of corresponding regions. The drains 5320 and the conductive materials 5331 to 5333 which extend in the third direction may be electrically coupled with through contact plugs. The conductive materials 5331 to 5333 which extend in the third direction may be a metallic material. The conductive materials 5331 to 5333 which extend in the third direction may be a conductive material such as polysilicon.

In FIGS. 5 and 6, the respective pillars 5113 may form strings together with the dielectric layer 5116 and the conductive materials 5211 to 5291, 5212 to 5292 and 5213 to 5293 which extend in the first direction. The respective pillars 5113 may form NAND strings NS together with the dielectric layer 5116 and the conductive materials 5211 to 5291, 5212 to 5292 and 5213 to 5293 which extend in the first direction. Each NAND string NS may include a plurality of transistor structures TS.

FIG. 7 is a cross-sectional view of the transistor structure TS shown in FIG. 6.

Referring to FIG. 7, in the transistor structure TS shown in FIG. 6, the dielectric layer 5116 may include first to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may include a thermal oxidation layer.

The second sub dielectric layer 5118 may serve as a charge storing layer. The second sub dielectric layer 5118 may serve as a charge capturing layer, and may include a nitride layer or a metal oxide layer such as an aluminum oxide layer, a hafnium oxide layer, or the like.

The third sub dielectric layer 5119 adjacent to the conductive material 5233 may serve as a blocking dielectric layer. The third sub dielectric layer 5119 adjacent to the conductive material 5233 which extends in the first direction may be formed as a single layer or multiple layers. The third sub dielectric layer 5119 may be a high-k dielectric layer such as an aluminum oxide layer, a hafnium oxide layer, or the like, which has a dielectric constant greater than the first and second sub dielectric layers 5117 and 5118.

The conductive material 5233 may serve as a gate or a control gate. That is, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment, for the sake of convenience, the surface layer 5114 of p-type silicon in each of the pillars 5113 will be referred to as a body in the second direction.

The memory block BLKi may include the plurality of pillars 5113. Namely, the memory block BLKi may include the plurality of NAND strings NS. In detail, the memory block BLKi may include the plurality of NAND strings NS which extend in the second direction or a direction perpendicular to the substrate 5111.

Each NAND string NS may include the plurality of transistor structures TS which are disposed in the second direction. At least one of the plurality of transistor structures TS of each NAND string NS may serve as a string source transistor SST. At least one of the plurality of transistor structures TS of each NAND string NS may serve as a ground select transistor GST.

The gates or control gates may correspond to the conductive materials 5211 to 5291, 5212 to 5292 and 5213 to 5293 which extend in the first direction. In other words, the gates or the control gates may extend in the first direction and form word lines and at least two select lines, at least one source select line SSL and at least one ground select line GSL.

The conductive materials 5331 to 5333 which extend in the third direction may be electrically coupled to one end of the NAND strings NS. The conductive materials 5331 to 5333 which extend in the third direction may serve as bit lines BL. That is, in one memory block BLKi, the plurality of NAND strings NS may be electrically coupled to one bit line BL.

The second type doping regions 5311 to 5314 which extend in the first direction may be provided to the other ends of the NAND strings NS. The second type doping regions 5311 to 5314 which extend in the first direction may serve as common source lines CSL.

Namely, the memory block BLKi may include a plurality of NAND strings NS which extend in a direction perpendicular to the substrate 5111, e.g., the second direction, and may serve as a NAND flash memory block, for example, of a charge capturing type memory, in which a plurality of NAND strings NS are electrically coupled to one bit line BL.

While it is illustrated in FIGS. 5 to 7 that the conductive materials 5211 to 5291, 5212 to 5292 and 5213 to 5293 which extend in the first direction are provided in 9 layers, it is to be noted that the conductive materials 5211 to 5291, 5212 to 5292 and 5213 to 5293 which extend in the first direction are not limited to being provided in 9 layers. For example, conductive materials which extend in the first direction may be provided in 8 layers, 16 layers or any multiple of layers. In other words, in one NAND string NS, the number of transistors may be 8, 16 or more.

While it is illustrated in FIGS. 5 to 7 that 3 NAND strings NS are electrically coupled to one bit line BL, it is to be noted that the embodiment is not limited to having 3 NAND strings NS that are electrically coupled to one bit line BL. In the memory block BLKi, m number of NAND strings NS may be electrically coupled to one bit line BL, m being a positive integer. According to the number of NAND strings NS which are electrically coupled to one bit line BL, the number of conductive materials 5211 to 5291, 5212 to 5292 and 5213 to 5293 which extend in the first direction and the number of common source lines 5311 to 5314 may be controlled as well.

Further, while it is illustrated in FIGS. 5 to 7 that 3 NAND strings NS are electrically coupled to one conductive material which extends in the first direction, it is to be noted that the embodiment is not limited to having 3 NAND strings NS electrically coupled to one conductive material which extends in the first direction. For example, n number of NAND strings NS may be electrically coupled to one conductive material which extends in the first direction, n being a positive integer. According to the number of NAND strings NS which are electrically coupled to one conductive material which extends in the first direction, the number of bit lines 5331 to 5333 may be controlled as well.

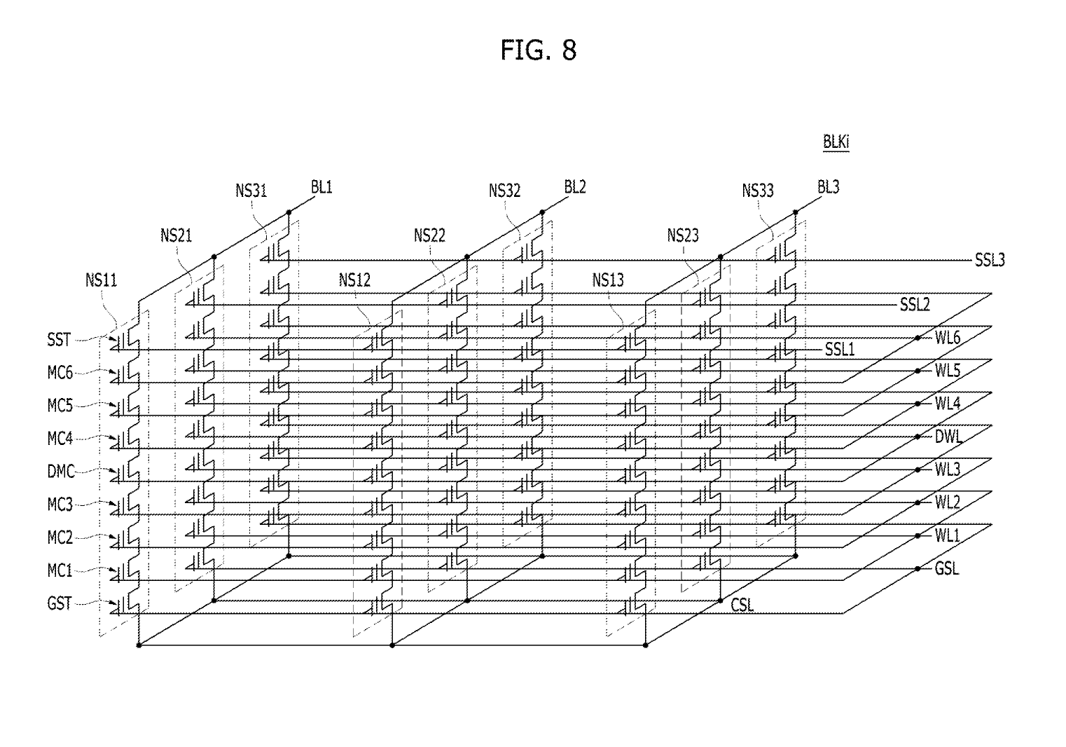

FIG. 8 is an equivalent circuit diagram illustrating the memory block BLKi having a first structure described with reference to FIGS. 5 to 7.

Referring to FIG. 8, in a block BLKi having the first structure, NAND strings NS11 to NS31 may be provided between a first bit line is BL1 and a common source line CSL. The first bit line BL1 may correspond to the conductive material 5331 of FIGS. 5 and 6, which extends in the third direction. NAND strings NS12 to NS32 may be provided between a second bit line BL2 and the common source line CSL. The second bit line BL2 may correspond to the conductive material 5332 of FIGS. 5 and 6, which extends in the third direction. NAND strings NS13 to NS33 may be provided between a third bit line BL3 and the common source line CSL. The third bit line BL3 may correspond to the conductive material 5333 of FIGS. 5 and 6, which extends in the third direction.

A source select transistor SST of each NAND string NS may be electrically coupled to a corresponding bit line BL. A ground select transistor GST of each NAND string NS may be electrically coupled to the common source line CSL. Memory cells MC may be provided between the source select transistor SST and the ground select transistor GST of each NAND string NS.

In this example, NAND strings NS may be defined in units of rows and columns and NAND strings NS which are electrically coupled to one bit line may form one column. The NAND strings NS11 to NS31 which are electrically coupled to the first bit line BL1 may correspond to a first column, the NAND strings NS12 to NS32 which are electrically coupled to the second bit line BL2 may correspond to a second column, and the NAND strings NS13 to NS33 which are electrically coupled to the third bit line BL3 may correspond to a third column. NAND strings NS which are electrically coupled to one source select line SSL may form one row. The NAND strings NS11 to NS13 which are electrically coupled to a first source select line SSL1 may form a first row, the NAND strings NS21 to NS23 which are electrically coupled to a second source select line SSL2 may form a second row, and the NAND strings NS31 to NS33 which are electrically coupled to a third source select line SSL3 may form a third row.

In each NAND string NS, a height may be defined. In each NAND string NS, the height of a memory cell MC1 adjacent to the ground select transistor GST may have a value ‘1’. In each NAND string NS, the height of a memory cell may increase as the memory cell gets closer to the source select transistor SST when measured from the substrate 5111. In each NAND string NS, the height of a memory cell MC6 adjacent to the source select transistor SST may be 7.

The source select transistors SST of the NAND strings NS in the same row may share the source select line SSL. The source select transistors SST of the NAND strings NS in different rows may be respectively electrically coupled to the different source select lines SSL1, SSL2 and SSL3.

The memory cells at the same height in the NAND strings NS in the same row may share a word line WL. That is, at the same height, the word lines WL electrically coupled to the memory cells MC of the NAND strings NS in different rows may be electrically coupled. Dummy memory cells DMC at the same height in the NAND strings NS of the same row may share a dummy word line DWL. Namely, at the same height or level, the dummy word lines DWL electrically coupled to the dummy memory cells DMC of the NAND strings NS in different rows may be electrically coupled.

The word lines WL or the dummy word lines DWL located at the same level or height or layer may be electrically coupled with one another at layers where the conductive materials 5211 to 5291, 5212 to 5292 and 5213 to 5293 which extend in the first direction may be provided. The conductive materials 5211 to 5291, 5212 to 5292 and 5213 to 5293 which extend in the first direction may be electrically coupled in common to upper layers through contacts. At the upper layers, the conductive materials 5211 to 5291, 5212 to 5292 and 5213 to 5293 which extend in the first direction may be electrically coupled. In other words, the ground select transistors GST of the NAND strings NS in the same row may share the ground select line GSL. Further, the ground select transistors GST of the NAND strings NS in different rows may share the ground select line GSL. That is, the NAND strings NS11 to NS13, NS21 to NS23 and NS31 to NS33 may be electrically coupled to the ground select line GSL.

The common source line CSL may be electrically coupled to the NAND strings NS. Over the active regions and over the substrate 5111, the first to fourth doping regions 5311 to 5314 may be electrically coupled with one another. The first to fourth doping regions 5311 to 5314 may be electrically coupled to an upper layer through contacts and, at the upper layer, the first to fourth doping regions 5311 to 5314 may be electrically coupled.

Namely, as shown in FIG. 8, the word lines WL of the same height or level may be electrically coupled. Accordingly, when a word line WL at a specific height is selected, all NAND strings NS which are electrically coupled to the word line WL may be selected. The NAND strings NS in different rows may be electrically coupled to different source select lines SSL. Accordingly, among the NAND strings NS electrically coupled to the same word line WL, by selecting one of the source select lines SSL1 to SSL3, the NAND strings NS in the unselected rows may be electrically isolated from the bit lines BL1 to BL3. In other words, by selecting one of the source select lines SSL1 to SSL3, a row of NAND strings NS may be selected. Moreover, by selecting one of the bit lines BL1 to BL3, the NAND strings NS in the selected rows may be selected in units of columns.

In each NAND string NS, a dummy memory cell DMC may be provided. In FIG. 8, the dummy memory cell DMC may be provided between a third memory cell MC3 and a fourth memory cell MC4 in each NAND string NS. That is, first to third memory cells MC1 to MC3 may be provided between the dummy memory cell DMC and the ground select transistor GST. Fourth to sixth memory cells MC4 to MC6 may be provided between the dummy memory cell DMC and the source select transistor SST. The memory cells MC of each NAND string NS may be divided into memory cell groups by the dummy memory cell DMC. In the divided memory cell groups, memory cells, for example, MC1 to MC3, adjacent to the ground select transistor GST may be referred to as a lower memory cell group, and memory cells, for example, MC4 to MC6, adjacent to the string select transistor SST may be referred to as an upper memory cell group.

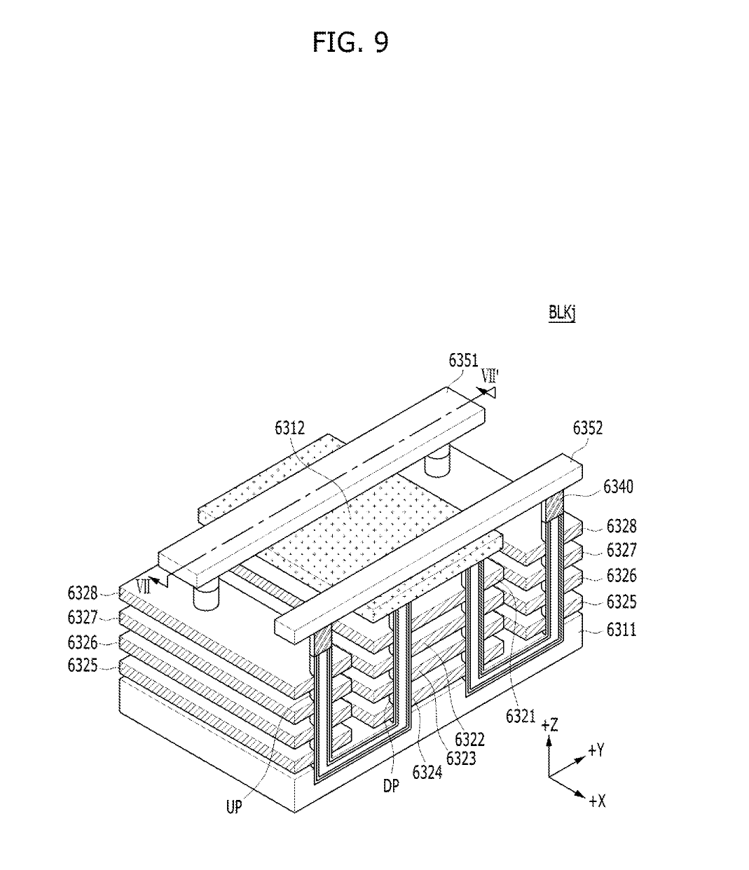

Hereinbelow, detailed descriptions will be made with reference to FIGS. 9 to 11, which show the memory device in the memory system in accordance with an embodiment implemented with a three-dimensional (3D) nonvolatile memory device different from the first structure.

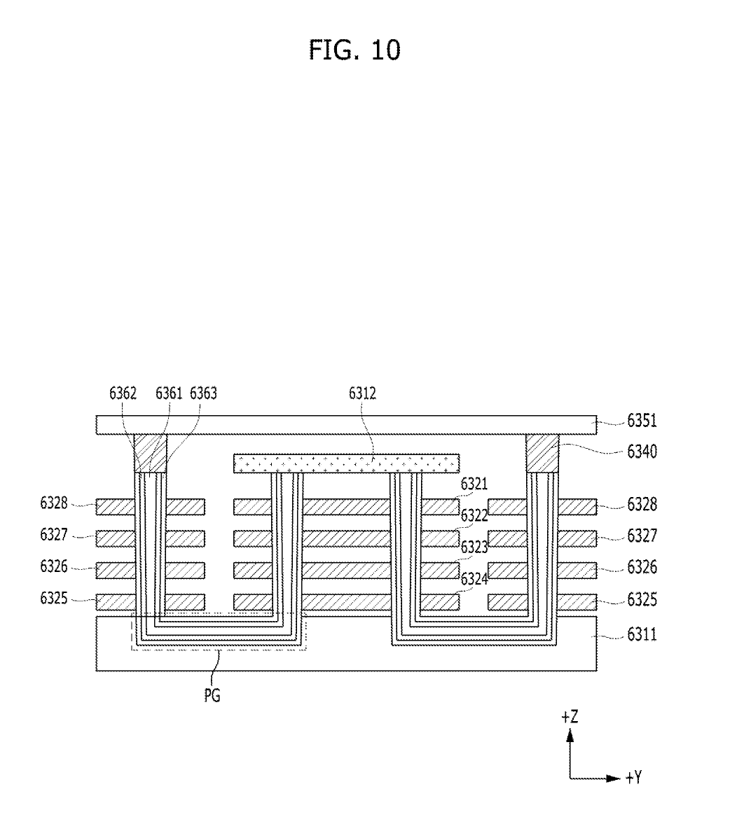

FIG. 9 is a perspective view schematically illustrating the memory device implemented with the three-dimensional (3D) nonvolatile memory device, which is different from the first structure described above with reference to FIGS. 5 to 8, and showing a memory block BLKj of the plurality of memory blocks of FIG. 4. FIG. 10 is a cross-sectional view illustrating a memory block BLKj taken along the line VII-VII′ of FIG. 9.

Referring to FIGS. 9 and 10, a memory block BLKj among the plurality of memory blocks of the memory device 150 of FIG. 1 may include structures which extend in the first to third directions.

A substrate 6311 may be provided. For example, the substrate 6311 may include a silicon material doped with a first type impurity. For example, the substrate 6311 may include a silicon material doped with a p-type impurity or may be a p-type well, for example, a pocket p-well, and include an n-type well which surrounds the p-type well. While it is assumed in the embodiment for the sake of convenience that the substrate 6311 is p-type silicon, it is to be noted that the substrate 6311 is not limited to p-type silicon.

First to fourth conductive materials 6321 to 6324 which extend in the x-axis direction and the y-axis direction are provided over the substrate 6311. The first to fourth conductive materials 6321 to 6324 may be separated by a predetermined distance in the z-axis direction.

Fifth to eighth conductive materials 6325 to 6328 which extend in the x-axis direction and the y-axis direction may be provided over the substrate 6311. The fifth to eighth conductive materials 6325 to 6328 may be separated by the predetermined distance in the z-axis direction. The fifth to eighth conductive materials 6325 to 6328 may be separated from the first to fourth conductive materials 6321 to 6324 in the y-axis direction.

A plurality of lower pillars DP which pass through the first to fourth conductive materials 6321 to 6324 may be provided. Each lower pillar DP extends in the z-axis direction. Also, a plurality of upper pillars UP which pass through the fifth to eighth conductive materials 6325 to 6328 may be provided. Each upper pillar UP extends in the z-axis direction.

Each of the lower pillars DP and the upper pillars UP may include an internal material 6361, an intermediate layer 6362, and a surface layer 6363. The intermediate layer 6362 may serve as a channel of the cell transistor, The surface layer 6363 may include a blocking dielectric layer, a charge storing layer and a tunneling dielectric layer.

The lower pillar DP and the upper pillar UP may be electrically coupled through a pipe gate PG. The pipe gate PG may be disposed in the substrate 6311. For instance, the pipe gate PG may include the same material as the lower pillar DP and the upper pillar UP.

A doping material 6312 of a second type which extends in the x-axis direction and the y-axis direction may be provided over the lower pillars DP. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive materials 6351 and 6352 which extend in the y-axis direction may be provided over the drains 6340.

The first and second upper conductive materials 6351 and 6352 may be separated in the x-axis direction. The first and second upper conductive materials 6351 and 6352 may be formed of a metal. The first and second upper conductive materials 6351 and 6352 and the drains 6340 may be electrically coupled through contact plugs. The first and second upper conductive materials 6351 and 6352 respectively serve as first and second bit lines BL1 and BL2.

The first conductive material 6321 may serve as a source select line SSL, the second conductive material 6322 may serve as a first dummy word line DWL1, and the third and fourth conductive materials 6323 and 6324 serve as first and second main word lines MWL1 and MWL2, respectively. The fifth and sixth conductive materials 6325 and 6326 serve as third and fourth main word lines MWL3 and MWL4, respectively, the seventh conductive material 6327 may serve as a second dummy word line DWL2, and the eighth conductive material 6328 may serve as a drain select line DSL.

The lower pillar DP and the first to fourth conductive materials 6321 to 6324 adjacent to the lower pillar DP form a lower string. The upper pillar UP and the fifth to eighth conductive materials 6325 to 6328 adjacent to the upper pillar UP form an upper string. The lower string and the upper string may be electrically coupled through the pipe gate PG. One end of the lower string may be electrically coupled to the doping material 6312 of the second type which serves as the common source line CSL. One end of the upper string may be electrically coupled to a corresponding bit line through the drain 6340.

One lower string and one upper string form one cell string which is electrically coupled between the doping material 6312 of the second type serving as the common source line CSL and a corresponding one of the upper conductive material layers 6351 and 6352 serving as the bit line BL.

That is, the lower string may include a source select transistor SST, the first dummy memory cell DMC1, and the first and second main memory cells MMC1 and MMC2. The upper string may include the third and fourth main memory cells MMC3 and MMC4, the second dummy memory cell DMC2, and a drain select transistor DST.

In FIGS. 9 and 10, the upper string and the lower string may form a NAND string NS, and the NAND string NS may include a plurality of transistor structures TS. Since the transistor structure included in the NAND string NS in FIGS. 9 and 10 is described above in detail with reference to FIG. 7, a detailed description thereof will be omitted herein.

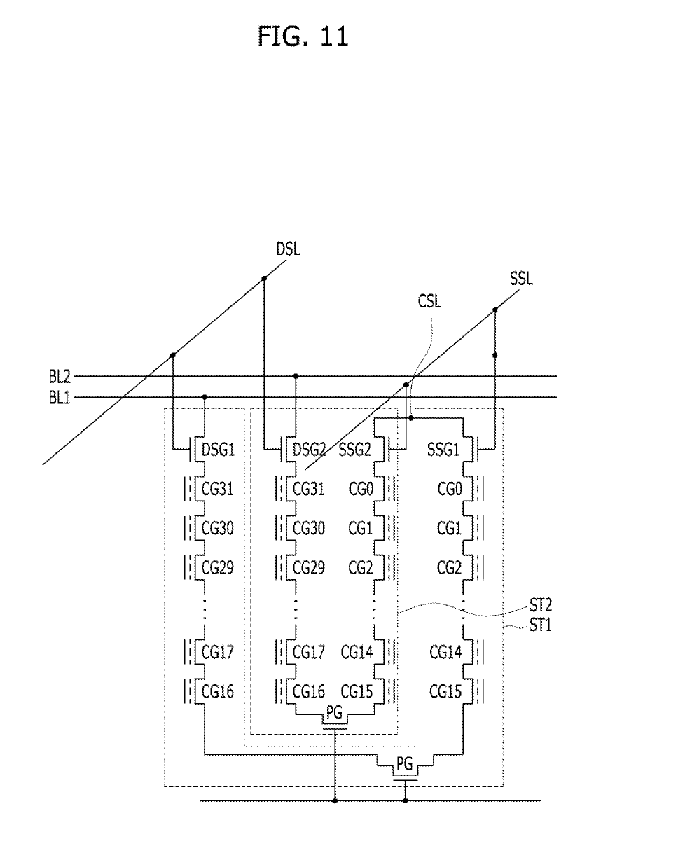

FIG. 11 is a circuit diagram illustrating the equivalent circuit of the memory block BLKj having the second structure as described above with reference to FIGS. 9 and 10. For the sake of convenience, only a first string and a second string, which form a pair in the memory block BLKj in the second structure, are shown.

Referring to FIG. 11, in a memory block BLKj having the second structure among the plurality of blocks of the memory device 150, cell strings, each of which is implemented with one upper string and one lower string electrically coupled through the pipe gate PG as described above with reference to FIGS. 9 and 10, may be provided to define a plurality of pairs.

Namely, in the memory block BLKj having the second structure, memory cells CG0 to CG31 stacked along a first channel CH1 (not shown), for example, at least one source select gate SSG1 and at least one drain select gate DSG1 may form a first string ST1, and memory cells CG0 to CG31 stacked along a second channel CH2 (not shown), for example, at least one source select gate SSG2 and at least one drain select gate DSG2 may form a second string ST2.

The first string ST1 and the second string ST2 may be electrically coupled to the same drain select line DSL and the same source select line SSL. The first string ST1 may be electrically coupled to a first bit line BL1, and the second string ST2 may be electrically coupled to a second bit line BL2.

While it is described in FIG. 11 that the first string ST1 and the second string ST2 are electrically coupled to the same drain select line DSL and the same source select line SSL, it may be envisaged that the first string ST1 and the second string ST2 may be electrically coupled to the same source select line SSL and the same bit line BL, the first string ST1 may be electrically coupled to a first drain select line DSL1 and the second string ST2 may be electrically coupled to a second drain select line DSL2. Further it may be envisaged that the first string ST1 and the second string ST2 may be electrically coupled to the same drain select line DSL and the same bit line BL, the first string ST1 may be electrically coupled to a first source select line SSL1 and the second string ST2 may be electrically coupled a second source select line SSL2.

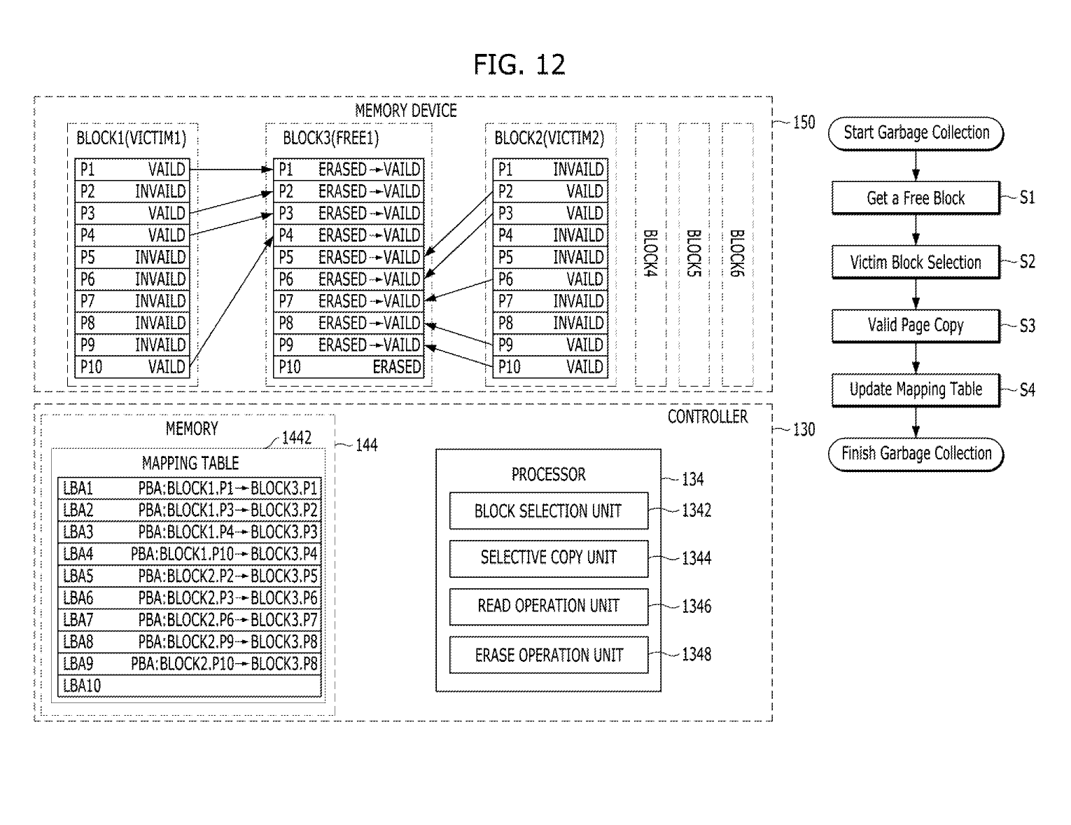

FIG. 12 is a schematic diagram illustrating a garbage collection operation of the memory system 110 in accordance with an embodiment.

FIG. 12 shows the memory device 150, and the memory 144 and the processor 134 of the controller 130 as described with reference to FIG. 1.

The memory device 150 includes a plurality of blocks BLOCK<1:6> each including a plurality of pages P<1:10>. FIG. 12 exemplarily shows 6 blocks BLOCK<1:6> included in the memory device 150, and 10 pages P<1:10> included in each of 6 blocks BLOCK<1:6>, which is not intended to limit the scope of the present invention. The number of blocks and pages may vary according to circuit design.

A mapping table as a storage unit 1442 for storing the mapping information of logical addresses LBA and physical addresses PBA included in the memory 144. Both of the physical addresses PBA and the logical addresses LBA may represent the plurality of pages P<1:10> included in each of the plurality of blocks BLOCK<1:6>. The storage unit 1442 may store the mapping relationship between the physical addresses PBA and the logical addresses LBA in a table.

The processor 134 includes a block selection unit 1342, a selective copy unit 1344, a read operation unit 1346, and an erase operation unit 1348.

The block selection unit 1342 selects victim blocks VICTIM1 and VICTIM2 and a free block FREE1 among the plurality of blocks BLOCK<1:6> for the garbage collection operation. In the present embodiment, descriptions will be made for the garbage collection operation after the selection of the victim blocks VICTIM1 and VICTIM2 and the free block FREE1.

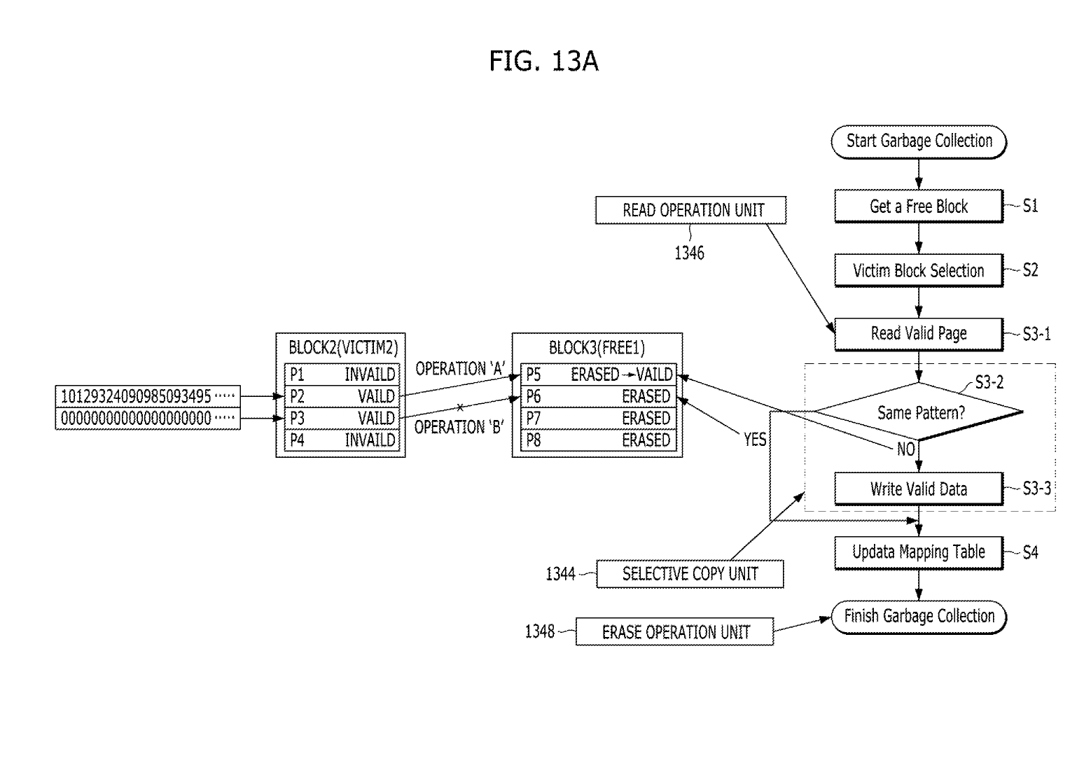

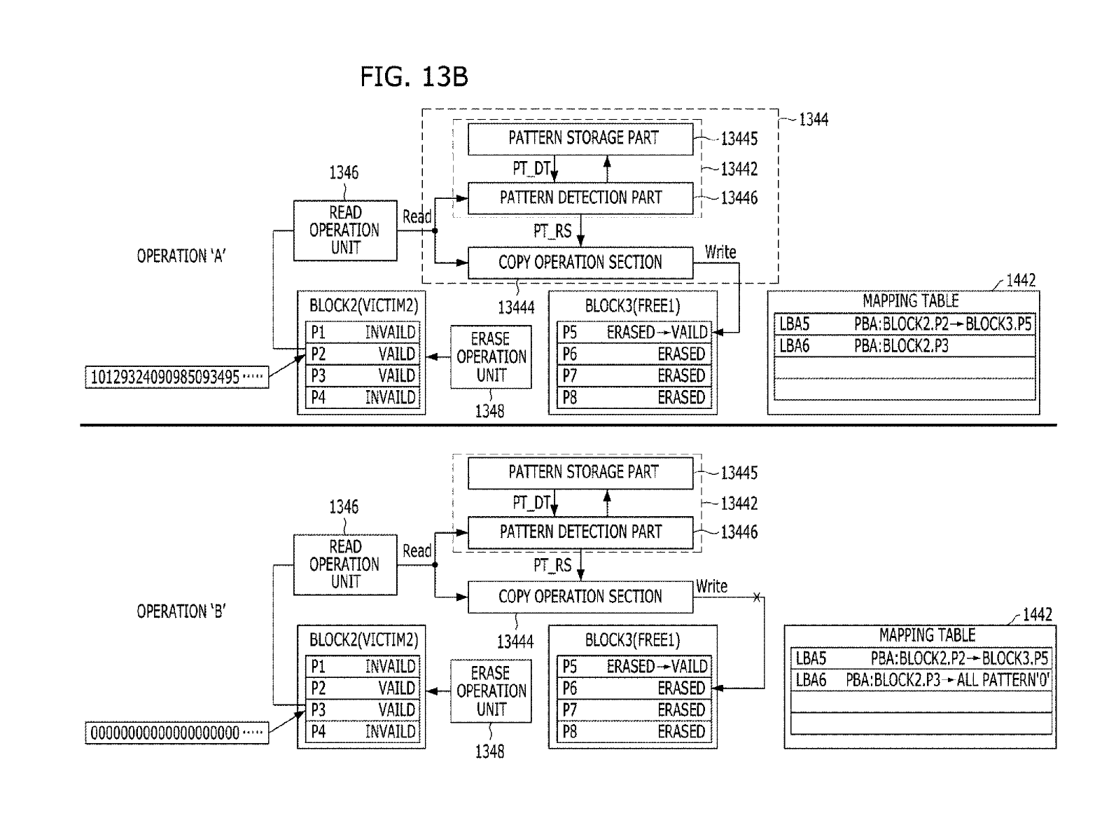

The read operation unit 1346 and the selective copy unit 1344 read and copy the data stored in the valid pages included in the victim blocks VICTIM1 and VICTIM2 to the free block FREE1. The selective copy unit 1344 in accordance with the embodiment may selectively copy the data stored in the valid pages in the victim blocks VICTIM1 and VICTIM2 to the free block FREE1, which will be described later with reference to FIGS. 13A and 13B.

The erase operation unit 1348 erases the victim blocks VICTIM1 and VICTIM2 after copying all the data stored in the valid pages of the victim blocks VICTIM1 and VICTIM2 to the free block FREE1.

FIG. 12 exemplarily shows first and second blocks BLOCK1 and BLOCK2 among the plural blocks BLOCK<1:6> as the victim blocks VICTIM1 and VICTIM2. The victim block has relatively large amounts of invalid pages due to repetitive data input/output operations.

Further, FIG. 12 exemplarily shows a third block BLOCK3 as the free block FREE1 full of erased pages.

For example, the block selection unit 1342 selects the third block BLOCK3 as the free block FREE1 and selects the first and second blocks BLOCK1 and BLOCK2 as the victim blocks VICTIM1 and VICTIM2, at steps S1 and S2 of a flow chart shown in FIG. 12. The flow chart may represent the garbage collection operation.

Next, the read operation unit 1346 and the selective copy unit 1344 copy the data of the valid pages included in the victim blocks VICTIM1 and VICTIM2 to the free block FREE1 at step S3 of the flow chart.

For example, the valid pages (the pages P1, P3, P4 and P10) included in the first block BLOCK1 or the victim block VICTIM1 are read by the read operation unit 1346 and are copied to first to fourth pages P<1:4> of the free block FREE1 by the selective copy unit 1344 at step S3 of the flow chart. In similar way, the valid pages (the pages P2, P3, P6, P9 and P10) included in the second block BLOCK2 or the victim block VICTIM2 are read by the read operation unit 1346 and are copied to fifth to ninth pages P<5:9> of the free block FREE1 by the selective copy unit 1344 at step S3 of the flow chart. Accordingly, the first to ninth pages P<1:9> of the free block FREE1 are updated from erased states to valid states.

Next, the information of the mapping table stored in the storage unit 1442 is updated, or the mapping information between physical addresses PBA and logical addresses LBA is updated at step S4 of the flow chart.

For example, a first logical address LBA1 is mapped to a physical address PBA designating the first page P1 of the first block BLOCK1 before the garbage collection operation, and now the first logical address LBA1 is mapped to a physical address PBA designating the first page P1 of the free block FREE1 as a update result of the step S4. In a similar way, a second logical address LBA2 is mapped to a physical address PBA designating the third page P3 of the first block BLOCK1 before the garbage collection operation, and now the second logical address LBA2 is mapped to a physical address PBA designating the second page P2 of the free block FREE1 as an update result of the step S4. In this way, the physical addresses PBA mapped to third to ninth logical addresses LBA<3:9> are all updated.

The erase operation unit 1348 erases the victim blocks VICTIM1 and VICTIM2 upon completion of the update of the mapping table of the storage unit 1442, which is due to the copying of the data stored in the valid pages of the victim blocks VICTIM1 and VICTIM2 to the free block FREE1. Therefore, all the pages stored in the victim blocks VICTIM1 and VICTIM2 are converted into erased states and free states through the garbage collection operation.

FIGS. 13A and 13B are schematic diagrams illustrating operations of the selective copy unit 1344 shown in FIG. 12.

FIGS. 13A and 13B exemplarily show the garbage collection operation. Steps S1 and 52 shown in FIG. 13 may be the same as the steps S1 and S2 described with reference to FIG. 12.

Referring to FIGS. 13A and 13B, at step S3-1, for example, the valid pages (the pages P1, P3, P4 and P10) included in the victim block VICTIM1 may be read by the read operation unit 1346. In a similar way, the valid pages (the pages P2, P3, P6, P9 and P10) included in the victim block VICTIM2 may be read by the read operation unit 1346 at step S3-1.

FIGS. 13A and 13B exemplarily show the selective copy unit 1344 performing steps S3-2 and S3-3 of copying the data of the valid pages (the second and third pages P<2:3>) of the victim block VICTIM2 to the free or erased pages (the fifth and sixth pages P<5:6>) of the free block FREE1.

At step S3-2, the selective copy unit 1344 performs operations ‘A’ and ‘B’ according to valid normal data or valid pattern data of the valid page, which will be described later. At step 3-2, it may be determined whether the read data of the valid second page P<2> of the victim block VICTIM2 has a predetermined pattern. That is to say, at step 3-2, it may be determined whether the read data of the valid page of the victim block is the valid pattern data.

When it is determined whether the read data of the valid second page P<2> of the victim block VICTIM2 does not have the predetermined pattern or the read data of the valid page of the victim block is the valid normal data (“NO” at step S3-2), the selective copy unit 1344 may perform the operation ‘A’ for the valid normal data, which is the same as the operation described with reference to FIG. 12. As the operation ‘A’, the valid normal data of the second page P<2> of the victim block VICTIM2 is written or copied to the fifth page P<5> of the free block FREE1 at step S3-3 of the flow chart. Next, the information of the mapping table stored in the storage unit 1442 may be updated, or the mapping information between physical addresses PBA and logical addresses LBA may be updated at step 54 of the flow chart, which is the same as step 54 described with reference to FIG. 12. The erase operation unit 1348 may erase the victim blocks VICTIM1 and VICTIM2 upon completion of the update of the mapping table of the storage unit 1442, which is due to the copy of the valid normal data stored in the valid pages of the victim blocks VICTIM1 and VICTIM2 to the free block FREE1. Summarizing these, in the case where the data of valid pages in the victim blocks VICTIM1 and VICTIM2 does not have the predetermined pattern or the read data of the valid page of the victim block is the valid normal data, the selective copy unit 1344 may copy the valid data of the valid pages to the free block FREE1.

When it is determined whether the read data of the valid second page P<2> of the victim block VICTIM2 has the predetermined pattern or the read data of the valid page of the victim block is the valid pattern data (“YES” at step S3-2), the selective copy unit 1344 may perform the operation ‘B’ for the valid pattern data. FIGS. 13A and 13B exemplarily show a sequence of repeated zeros as the predetermined pattern. As the operation ‘B’ for the valid pattern data, the valid pattern data of the valid third page P<3> in the victim block is not copied to the free block FREE1. Step S4 of updating the mapping table in the operation ‘B’ will be described later. The erase operation unit 1348 may erase the victim blocks VICTIM1 and VICTIM2 upon completion of the update of the mapping table of the storage unit 1442. Summarizing, in the case where the data of valid pages in the victim blocks VICTIM1 and VICTIM2 has the predetermined pattern or the read data of the valid page of the victim block is the valid pattern data, the selective copy unit 1344 may not copy the patterned data of the valid pages to the free block FREE1.

Referring to FIG. 13B, the selective copy unit 1344 includes a selection operation section 13442 and a copy operation section 13444. The selection operation section 13442 includes a pattern storage part 13445 and a pattern detection part 13446.

Referring to FIGS. 13A and FIG. 13B, at step S3-2 of the garbage collection operation, the selective copy unit 1344 may determine whether the data stored in N number of the valid pages included in the victim blocks VICTIM1 and VICTIM2 have the predetermined pattern PT_DT or the read data of the N numbers of valid page of the victim block is the valid pattern data. As a result PT_RS of the determination, the valid normal data not having the predetermined pattern PT_DT in M (M is smaller than N) of the N number of valid pages included in the victim blocks VICTIM1 and VICTIM2 may be copied to the free block FREE1. Conversely, as the determination result PT_RS, the valid pattern data having the predetermined pattern PT_DT in the remaining N-M of the N number of valid pages included in the victim blocks VICTIM1 and VICTIM2 may not be copied to the free block FREE1.

That is, the selection operation section 13442 at step 3-2 determines whether the data respectively stored in the N number of valid pages included in the victim blocks VICTIM1 and VICTIM2 is the valid pattern data or the valid normal data. According to the determination results PT_RS, the M number of valid normal pages storing the valid normal data and N-M number of valid pattern pages storing the valid pattern data may be identified.

In detail, the selection operation section 13442 at step S3-2 determines whether the data stored in the valid page of the victim block has the predetermined pattern PT_DT, or the data stored in the valid page of the victim block is the valid pattern data, or the valid page is the valid pattern page. When the data stored in the valid page of the victim block has the predetermined pattern PT_DT, the data may be determined as the valid pattern data and the valid page may be determined as the valid pattern page. When the data stored in the valid page of the victim block does not have the predetermined pattern PT_DT, the data may be determined as the valid normal data and the valid page may be determined as the valid normal page. The selection operation section 13442 may generate the determination result PT_RS according to the determination. When the valid page is determined as the valid normal page, the determination result PT_RS may be enabled to store the valid normal data of the valid normal page to the free block. When the valid page is determined as the valid pattern page, the determination result PT_RS may be disabled not to store the valid pattern data of the valid pattern page to the free block.

The pattern storage part 13445 included in the selection operation section 13442 stores the predetermined pattern PT_DT.

The pattern storage part 13445 may be included in a specified region in the processor 134 or may be included in the memory 144 separately from the processor 134. A number of the predetermined pattern PT_DT in variety may vary according to a designer's choice. It is assumed that the number of various predetermined patterns PT_DT is K.

In the selection operation section 13442, the pattern detection part 13446 at step S3-2 detects the valid pattern data of the valid pattern page among the data stored in the N number of valid pages included in the victim blocks VICTIM1 and VICTIM2 through the determination result PT_RS stored in the pattern storage part 13445.

At step S3-3, the copy operation section 13444 may write or copy the valid normal data of the valid normal page to the free block in response to the determination result PT_RS.

For example, the selective copy unit 1344 at step S3-2 determines whether the data stored in the second and third valid pages P<2:3> of the victim block VICTIM2 has the predetermined pattern PT_DT or is the valid pattern data. When the second valid page P<2> is determined to have the valid normal data, the determination result PT_RS may be enabled to store the valid normal data of the valid normal page P<2> to the free block FREE1. When the third valid page P<3> is determined to have the valid pattern data, the determination result PT_RS may be disabled not to store the valid pattern data of the valid pattern page P<3> to the free block FREE1. Therefore, the valid normal data stored in the valid normal page P<2> is copied to the fifth page P<5> of the free block FREE1, and the valid pattern data stored in the valid pattern page P<3> is not copied to the free block FREE1.

At step S3-3, in response to the enabled determination result PT_RS, the copy operation section 13444 writes the valid data stored in the M number of valid normal pages to the free pages included in the free block FREE1. At step S3-3, in response to the disabled determination result PT_RS, the copy operation section 13444 may not write the valid pattern data stored in the N-M number of valid pattern pages to the free block FREE1.

For example, in response to the enabled determination result PT_RS, the copy operation section 13444 writes the valid normal data stored the valid normal page P<2> to the fifth page P<5> of the free block FREE1. In response to the disabled determination result PT_RS, the copy operation section 13444 does not write the valid pattern data stored in the valid pattern page P<3> to the free block FREE1.

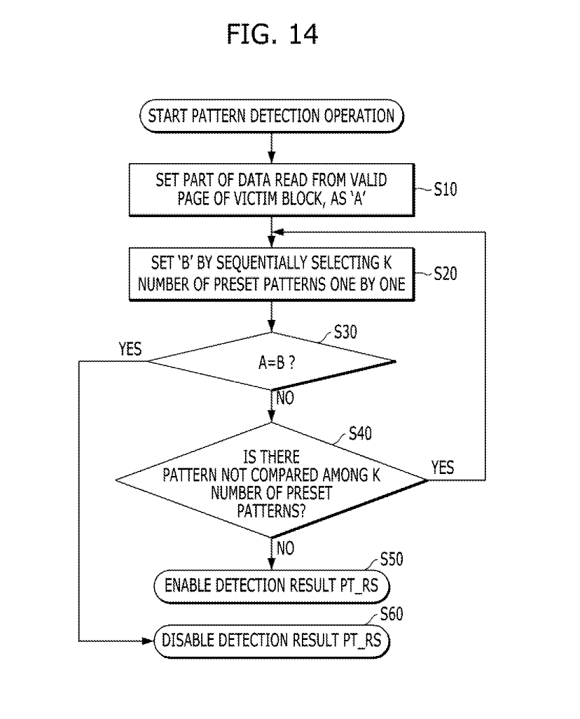

FIG. 14 is a flow chart illustrating an operation of the selective copy unit 1344 shown in FIG. 12.

Referring to FIG. 14, when the data respectively stored in the N number of valid pages included in the victim blocks VICTIM1 and VICTIM2 are respectively inputted, the pattern detection part 13446 may set part of the inputted data of each valid page as ‘A’ at step 510. The reason why the part of inputted data is set is because the inputted data, which is stored in the valid page, is large. It may be sufficient to compare the part of the inputted data with the predetermined pattern, as described later at step S30.

At step S20, the pattern detection part 13446 may set each of the K number of predetermined patterns PT_DT stored in the pattern storage part 13445 as ‘B’.

At step S30, the pattern detection part 13446 may compare the data ‘A’ with the predetermined pattern PT_DT set as ‘B’.

When the data ‘A’ and the predetermined pattern PT_DT set as ‘B’ are the same as a result of the comparison in the step S30 (YES), the pattern detection part 13446 may determine the inputted data to have the predetermined pattern PT_DT and thus as the valid pattern data. Therefore, the pattern detection part 13446 may disable the determination result PT RS so that the valid pattern data is not copied in the free block FREE1.

When the data ‘A’ and the predetermined pattern PT_DT set as ‘B’ are not the same as a result of the comparison in the step S30, the pattern detection part 13446 may determine whether all of the K number of predetermined pattern PT_DT are compared with the data ‘A’ at step S40.

When it is determined that all of the K number of predetermined pattern PT_DT are not compared with the data ‘A’, the pattern detection part 13446 may repeat steps S20 to S40 with another available one among the K number of predetermined patterns PT_DT until all of the K number of predetermined pattern PT_DT are compared with the data ‘A’.

When it is determined that all of the K number of predetermined pattern PT_DT are compared with the data ‘A’ at step S40, the pattern detection part 13446 may determine the inputted data not to have the predetermined pattern PT_DT and thus be the valid normal data. Therefore, the pattern detection part 13446 may enable the determination result PT_RS in order to copy the valid normal data in the free block FREE1.

The pattern detection part 13446 may perform the operation described with reference to FIG. 14 for all data in the valid pages of the victim blocks.

Step S4 of updating the mapping table in the operation ‘B’ is described below.

As described above with reference to FIG. 12, before the garbage collection operation, the storage unit 1442 stores the mapping information between the physical addresses PBA and logical addresses LBA for the plurality of pages P<1:10> in each of the plurality of blocks BLOCK<1:6> of the memory device 150. At this time, the mapping information may represent the relationship between the logical addresses LBA and the physical addresses PBA for the M number of valid normal pages included in the victim blocks VICTIM1 and VICTIM2. Further, at this time, the mapping information may represent the relationship between the logical addresses LBA and the physical addresses PBA for the N-M number of valid pattern pages included in the victim blocks VICTIM1 and VICTIM2. The valid normal page may store the valid normal data and the valid pattern page may store the valid pattern data.

Referring again to FIGS. 13A and 13B, for example, before the garbage collection operation, the logical addresses LBA<5:6> and the physical addresses PBA:BLOCK2.P2 and PBA:BLOCK2.P3 corresponding to the second and third valid pages P<2:3> included in the victim block VICTIM2 are mapped to each other in the storage unit 1442.

At step S4 during the garbage collection operation, the storage unit 1442 updates the mapping information to represent the relationship between the logical addresses LBA and the physical addresses PBA for the valid normal data currently stored in the free block. Further, at step S4 during the garbage collection operation, the storage unit 1442 updates the mapping information to represent the relationship between the logical addresses LBA and the predetermined patterns PT_DT of the valid pattern data, which are not stored in the free block.

Referring again to FIGS. 13A and 13B, for example, at step S4 during the garbage collection operation, the storage unit 1442 may update the mapping information to represent the relationship between the fifth logical addresses LBA5 and the physical addresses PBA:BLOCK3.P5 for the valid normal data currently stored in the fifth page P<5> of the free block FREE1. That is to say, the fifth logical address LBA5 of the storage unit 1442 may be mapped to the second valid normal page P<2> of the victim block VICTIM2 before the garbage collection operation, and may be mapped to the fifth page P<5> of the free block FREE1 according to the mapping information update during the garbage collection operation.

Also referring again to FIGS. 13A and 13B, for example, at step S4 during the garbage collection operation, the storage unit 1442 updates the mapping information to represent the relationship between the sixth logical addresses LBA6 and the predetermined patterns PT_DT (ALL PATTERN ‘0’) of the valid pattern data stored in the third valid pattern page P<3> of the victim block VICTIM2, which are not stored in the free block. Namely, the sixth logical address LBA6 of the storage unit 1442 may be mapped to the third valid normal page P<3> of the victim block VICTIM2 before the garbage collection operation, and may be mapped to the predetermined pattern PT_DT (ALL PATTERN ‘0’) of the valid pattern data stored in the third valid pattern page P<3> of the victim block VICTIM2 according to the mapping information update during the garbage collection operation.

As described above, the N-M number of valid pattern pages having the predetermined patterns PT_DT among the N number of valid pages included in the victim blocks VICTIM1 and VICTIM2 are not copied to the free block FREE1 during the garbage collection operation, and thus physical space in the memory device 150 may be saved after the garbage collection operation. Instead, the memory 144 may store the N-M number of predetermined patterns PT_DT, which are mapped to the N-M number of logical addresses LBA for the valid pattern data of the valid pattern pages due to the mapping information update during the garbage collection operation.

The memory device 150 is a nonvolatile memory device which has a relatively low operation speed while the memory 144 is a volatile memory device which has a relatively high operation speed. In accordance with an exemplary embodiment of the present invention, it is only the valid normal data of the valid normal page in the victim block to which the copy operation is performed with the free block of the memory device 150, while the memory 144 stores the predetermined patterns PT_DT mapped to the logical addresses LBA for the valid pattern data of the valid pattern pages through the mapping information update instead of the copy operation with the free block of the memory device 150 during the garbage collection operation. The selective copy operation and the mapping information update may take shorter less than the full copy operation and the mapping information update according to the prior art. That is to say, according to the present embodiment, it is possible to shorten the time required to perform the garbage collection operation.

Further, during a read operation after the garbage collection operation, the read operation unit 1346 may generate the valid pattern data by using the predetermined patterns PT_DT stored in the mapping table of the memory 144 in response to a read command having the corresponding logical addresses LBA for the valid pattern data. For example, as shown in FIG. 13B, when the read command with the sixth logical address LBA6 is inputted, the read operation unit 1346 may generate the valid pattern data by repeatedly concatenating the predetermined patterns PT_DT (ALL PATTERN ‘0’) mapped to the sixth logical address LBA6 in the mapping table of the memory 144. That is, the valid pattern data may not be read out from the memory device 150 but may be generated from the memory 144. The generation of the valid pattern data from the memory 144, which may be volatile, may take less time than the read out from the memory device 150, which may be nonvolatile. That is to say, according to the present embodiment, it is possible to shorten the time required to perform the read operation.

Moreover, the saved physical space in the memory device 150 due to the valid pattern data may be allocated to the valid normal data, and thus the number of valid pages to be copied from the victim blocks VICTIM1 and VICTIM2 to the free block FREE1 may be maximized.

Although various embodiments have been described for illustrative purposes, it will be apparent to those skilled in the art that various changes and modifications may be made without departing from the spirit and scope of the invention as defined in the following claims.

For instance, positions and types of logic gates and transistors described as examples in the above embodiments could be differently realized depending on the polarities of the signals inputted thereto.

What is claimed is:

1. A memory system comprising:
multiple blocks each including multiple pages;
a selective copy unit suitable for determining whether data stored in each of multiple valid pages included in a victim block has a predetermined pattern, and copying valid normal data to a free block; and
a storage unit suitable for updating mapping information of a logical address for a valid pattern data to the predetermined pattern of the valid pattern data,
wherein the valid normal data does not have the predetermined pattern, and is originally stored in a valid normal page,
wherein the valid pattern data has the predetermined pattern, and is originally stored in a valid pattern page, and
wherein the valid normal page and the valid pattern page is included in the multiple valid pages.

2. The memory system according to claim 1, further comprising an erase operation unit suitable for performing an erase operation to the victim block.

3. The memory system according to claim 1, wherein the storage unit further updates mapping information of a logical address for the valid normal data to a physical address for the valid normal page copied to the free block.

4. The memory system according to claim 1, wherein the selective copy unit comprises:
a selection operation section suitable for determining whether each of the multiple valid pages is the valid normal page or the valid pattern page, and selectively enabling a determination result signal according to a result of the determination; and
a copy operation section suitable for copying the valid normal data to the free block in response to the determination result signal.

5. The memory system according to claim 4, wherein the selection operation section comprises:
a pattern storage part suitable for storing the predetermined pattern; and
a pattern detection part suitable for determining whether each of the multiple valid pages is the valid normal page or the valid pattern page by comparing the data stored in each of the multiple valid pages with the predetermined pattern, and selectively enabling a determination result signal according to a result of the determination.

6. The memory system according to claim 5,
wherein the pattern storage part stores multiple predetermined patterns that are different, and
wherein the pattern detection part compares part of the data stored in each of the multiple valid pages with each of the multiple predetermined patterns.

7. The memory system according to claim 6, wherein the storage unit stores one among the multiple predetermined patterns, which the valid pattern data has, along with the logical address for the valid pattern data.

8. The memory system according to claim 1, further comprising a read operation unit suitable for generating and outputting data by using the predetermined pattern of the valid pattern data in response to a read command having the logic address for the valid pattern data.

9. The memory system according to claim 8, wherein the read operation unit generates the data by repeatedly concatenating the predetermined pattern of the valid pattern data.

10. A method for operating a memory system including a plurality of blocks each including a plurality of pages, the method comprising:
determining whether data stored in each of multiple valid pages included in a victim block has a predetermined pattern, and copying valid normal data to a free block; and
updating mapping information of a logical address for a valid pattern data to the predetermined pattern of the valid pattern data,
wherein the valid normal data does not have the predetermined pattern, and is originally stored in a valid normal page,
wherein the valid pattern data has the predetermined pattern, and is originally stored in a valid pattern page, and
wherein the valid normal page and the valid pattern page is included in the multiple valid pages.

11. The method according to claim 10, further comprising performing an erase operation to the victim block.

12. The method according to claim 10, further comprising updating mapping information of a logical address for the valid normal data to a physical address for the valid normal page copied to the free block.

13. The method according to claim 10, wherein the determining and copying comprises:
determining whether each of the multiple valid pages is the valid normal page or the valid pattern page, and selectively enabling a determination result signal according to a result of the determination; and
copying the valid normal data to the free block in response to the determination result signal.

14. The method according to claim 13, wherein the determining is performed by comparing the data stored in each of the multiple valid pages with the predetermined pattern.

15. The method according to claim 14,
wherein there are multiple predetermined patterns,
wherein the multiple predetermined patterns are different and
wherein the comparing compares part of the data stored in each of the multiple valid pages with each of the multiple predetermined patterns.

16. The memory system according to claim 15, wherein the updating stores one of the multiple predetermined patterns, which the valid pattern data has, along with the logical address for the valid pattern data.

17. The memory system according to claim 10, further comprising generating and outputting data by using the predetermined pattern of the valid pattern data in response to a read command having the logic address for the valid pattern data.

18. The memory system according to claim 17, wherein the generating of data generates the data by repeatedly concatenating the predetermined pattern of the valid pattern data.

19. A memory controller comprising:
a determination means suitable for determining whether valid data of a victim block within a memory device is a valid normal data or a valid pattern data in order to allow the memory device to copy the valid normal data to a free block within the memory device;
a map management means suitable for updating mapping information of a logical address for the valid pattern data to a predetermined pattern of the valid pattern data, and updating mapping information of the logical address for the valid normal data to a physical address for the valid normal data copied to the free block; and
an erase means suitable for allowing the memory device to perform an erase operation to the victim block,
wherein the valid normal data does not have the predetermined pattern, and
wherein the valid pattern data has the predetermined pattern.
